(19) United States
(12) Patent Application Publication
(10) Pub. No.: US 2010/0291259 A1
(43) Pub. Date: Nov. 18, 2010

(54) INJECTION MOLD FOR MAKING WEDGE-SHAPED LIGHT GUIDE PLATE

(75) Inventor: HSI-CHANG WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/649,472

(22) Filed: Dec. 30, 2009

(30) Foreign Application Priority Data
May 13, 2009 (CN) 200910302264.1

(51) Int. Cl. B29C 45/27

(52) U.S. Cl. 425/573

(57) ABSTRACT

An exemplary injection mold for making wedge-shaped light guide plate includes a molding assembly with a mold cavity defined therein, and a first sprue and a second sprue in communication with the mold cavity. The mold cavity is wedge-shaped and comprises a thick end and a thin end opposite to the thick end. The first and second sprues are configured for introducing a molding material into the mold cavity. The first sprue is located at the thick end of the mold cavity, and the second is located at the thin end thereof.

### BACKGROUND

1. Technical Field

The present disclosure relates to injection molds, and particularly, to an injection mold for making a wedge-shaped light guide plate.

2. Description of Related Art

In a typical liquid crystal display, a backlight module provides a surface light source for illuminating the liquid crystal display. Generally, the backlight module includes a light guide plate and a light source arranged adjacent to one side of the light guide plate. The light guide plate changes light beams received from the light source into surface light beams, and directs the surface light beams to a liquid crystal panel of the liquid crystal display. Typically, the light guide plate has either of two shapes: a sheet having a uniform thickness, or a wedge-shaped sheet.

The wedge-shaped light guide plate has a thick end and an opposite thin end. The wedge-shaped light guide plate is commonly made by using an injection mold. The injection mold defines a wedge-shaped mold cavity for receiving molding materials. A sprue is formed in communication with the mold cavity for introducing molding materials into the mold cavity. However, the number of the sprue is usually only one that formed adjacent to a thick end of the mold cavity. Such structure makes it time-consuming for molding and the thin end of the mold cavity may be full and begin to solidify when the thick end of the mold cavity has unfilled space. Thus, the molding materials in the thin end of the mold cavity may be solidified earlier than those in the thick end of the mold cavity such that internal stresses in the light guide plate formed by using such injection mold are not distributed uniformly.

An injection mold for making wedge-shaped light guide plate which can overcome above shortcomings is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a disassembled isometric view of a first embodiment of an injection mold for making a wedge-shaped light guide plate.

FIG. 2 is an assembled isometric view of the injection mold in FIG. 1.

FIG. 3 is an isometric view of a wedge-shaped light guide plate made using the injection mold in FIG. 1.

FIG. 4 is a disassembled isometric view of a second embodiment of an injection mold.

FIG. 5 is a disassembled isometric view of a third embodiment of an injection mold.

### DETAILED DESCRIPTION

Embodiments of the present injection mold will now be described in detail below with reference to the drawings.

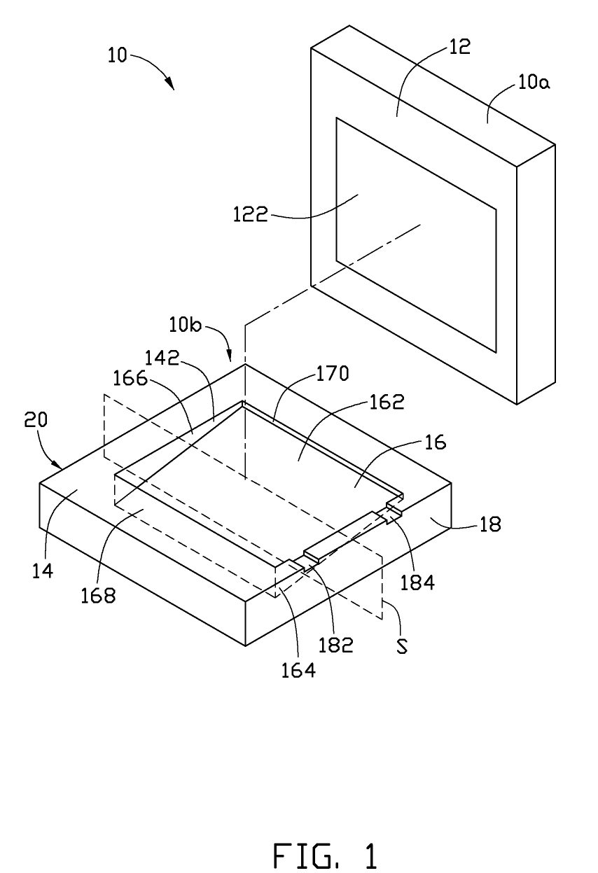

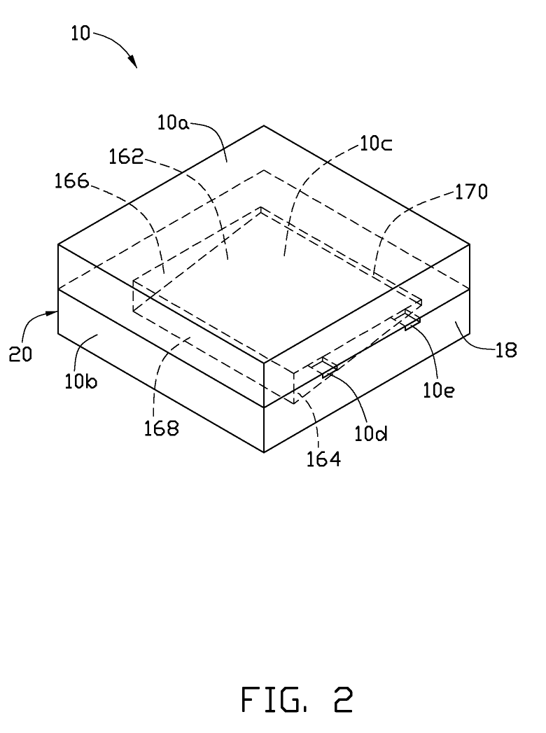

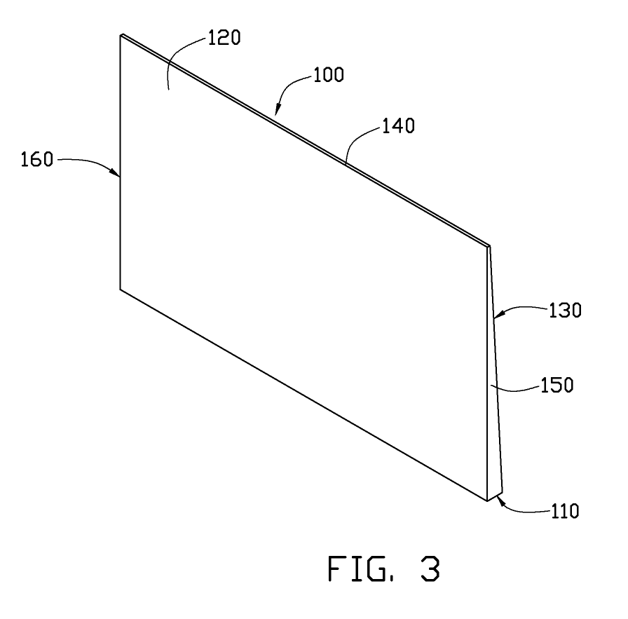

Referring to FIG. 1, an injection mold 10 in accordance with a first exemplary embodiment includes a first mold half 10a and a second mold half 10b. The first and second mold halves 10a and 10b cooperatively define a mold cavity (see mold cavity 10c in FIG. 2) for forming a wedge-shaped light guide plate 100 (see the wedge-shaped light guide plate in FIG. 3).

The first mold half 10a is generally cuboid. The first mold half 10a has a bottom surface 12. A rectangular molding surface 122 is defined at the center of the bottom surface 12. The rectangular molding surface is part of the bottom surface 12 and configured for pressing a mold material in the mold cavity to form a light emitting surface 120 of the wedge-shaped light guide plate 100.

The second mold half 10b is also generally cuboid. The second mold half 10b has a top surface 14 and two opposite outer side faces 18 and 20. A wedge-shaped recess 16 is defined in the top surface 14. The wedge-shaped recess 16 includes a rectangular opening 142 at the top surface 14. The rectangular opening 142 has a substantially same shape and substantially equal dimension to the rectangular molding surface 122.

The second mold half 10b has a bottom surface 162, two opposite trapeziform side faces 164 and 166, and two opposite rectangular side faces 168 and 170 in the wedge-shaped recess 16. The bottom surface 162 and the side faces 164, 166, 168 and 170 cooperatively bound the wedge-shaped recess 16. The two trapeziform side faces 164 and 166 face towards and are parallel with each other. The two rectangular side faces 168 and 170 face towards and are parallel with each other. In this embodiment, the side faces 164, 166, 168 and 170 are perpendicular with the top surface 14. Both of the two trapeziform side faces 164 and 166 interconnect and are perpendicular with the two rectangular side faces 168 and 170. The rectangular side face 168 has a larger depth relative to the top surface 14 than that of the rectangular side face 168, thus, the depth of each of the trapeziform side faces 164 and 166 gradually decreases from the rectangular side face 168 to the rectangular side face 170. That is, the bottom surface 162 inclines to the top surface 14. In this embodiment, the trapeziform side face 164 is adjacent to and parallel to the outer side face 18, and the trapeziform side face 166 is adjacent to and parallel to the outer side face 20.

A first groove 182 and a second groove 184 are defined in the top surface 14 of the second mold half 10b. In this embodiment, the first and second grooves 182 and 184 extend through the trapeziform side face 164 and the outer side face 18. The first groove 182 is adjacent to the rectangular side face 168, and the second groove 184 is adjacent to the rectangular side face 170. That is, the first groove 182 is adjacent to a thick end of the recess 16 and the second groove 184 is adjacent to a thin end of the recess 16. An imaginary middle surface S is defined parallel to and in the middle of the rectangular surfaces 168 and 170. In an alternative exemplary embodiment, the first groove 182 is located between the middle surface S and the rectangular side face 168, and the second groove 184 is located between the middle surface S and the rectangular side face 1700.

In this embodiment, the first and second grooves 182 and 184 are cuboid. It is to be understood that in alternative embodiments, the first and second grooves 182 and 184 can also be cylindrical.

Referring to FIG. 2, when the first mold half 10a and the second mold half 10b are attached to each other, the bottom surface 12 of the first mold half 10a presses the top surface 14 of the second mold half 10b. An interface between the first mold half 10a and the second mold half 10b is formed by the bottom surface 12 and the top surface 14. The rectangular molding surface 122 is arranged at the rectangular opening 142, thereby forming a wedge-shaped mold cavity 10c bounded by the bottom surface 162, the side faces 164, 166, 168 and 170 and the rectangular molding surface. The first and second grooves 182 and 184, and the bottom surface 12 cooperatively form two sprues 10d and 10e. The sprues 10d and 10e are configured for introducing a liquid molding material such as polymethyl methacrylate (PMMA) into the mold cavity 10c. When the molding material is injected and then solidified, a wedge-shaped light guide plate is formed in the wedge-shaped mold cavity 10c. It is to be understood that in alternative embodiments, the number of the sprues adjacent to the thick end or the thin end can be more than one.

Referring to FIG. 3, a wedge-shaped light guide plate 100 formed by using the injection mold 10. The wedge-shaped light guide plate 100 includes a light incident surface 110, a light emitting surface 120 adjacent to the light incident surface 110, and a bottom surface 130 facing away from the light emitting surface 120. The wedge-shaped light guide plate 100 further includes a first side face 140 facing away from the light incident surface 110, a second side face 150 and a third side face 160. The second and third side faces 150 and 160 are facing away from each other and are adjacent to all of the first side face 140, the light incident surface 110 and the light emitting surface 120.

Referring also to FIG. 1, the light incident surface 110 corresponds to the rectangular side face 168, the light emitting surface corresponds to the rectangular molding surface, the bottom surface 130 corresponds to the bottom surface 162, the first side face 140 corresponds to the rectangular side face 170, the second side face 150 corresponds to the trapeziform side face 164, and the third face 160 corresponds to the trapeziform side face 166. Therefore, a thickness of the wedge-shaped light guide plate 100 decreases from the light incident surface 110 to the first side face 140.

In the injection mold 10 of the illustrated embodiment, there are a sprue 10d adjacent to the thick end of the mold cavity 10c and a sprue 10e adjacent to the thin end of the mold cavity 10c. Therefore, the injection process for the thick end of the mold cavity 10c can take almost the same amount time with the injection process for the thin end of the mold cavity 10c. That is, the molding materials in the thick end of the mold cavity 10c can solidify almost at the same time with those in the thin end of the mold cavity 10c. Thus, the stresses in the wedge-shaped light guide plate 100 can distribute substantially uniformly.

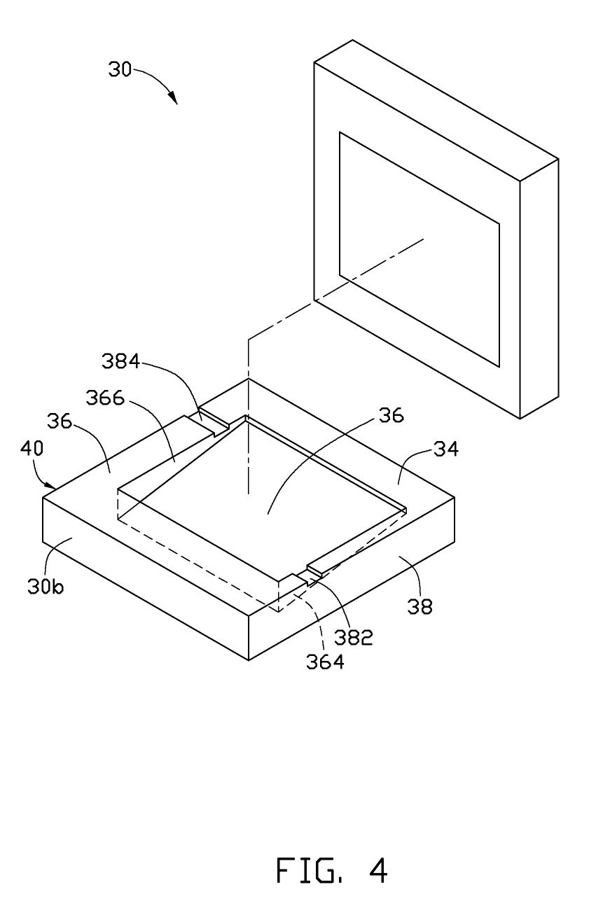

Referring to FIG. 4, this shows an injection mold 30 of a second exemplary embodiment. The injection mold 30 differs from the injection mold 10 as follows. The injection mold 30 includes a first groove 382 and a second groove 384 formed in a top surface 34 of a second mold 30b. In this embodiment, a trapeziform side face 364 corresponds to the trapeziform side face 164 of the first embodiment, and a trapeziform side face 366 corresponds to the trapeziform side face 166 of the first embodiment. An outer side face 38 of the second mold half 30b is adjacent to and parallel with the trapeziform side face 364, and an outer side face 40 of the second mold half 30b is adjacent to and parallel with the trapeziform side face 366. The groove 382 extends through the trapeziform side face 364 and the outer side face 38, and the groove 384 extends through the trapeziform side face 366 and the outer side face 40. The groove 382 is adjacent to a thick end of a wedge-shaped recess 36, and the groove 384 is adjacent to an opposite thin end of the wedge-shaped recess 36.

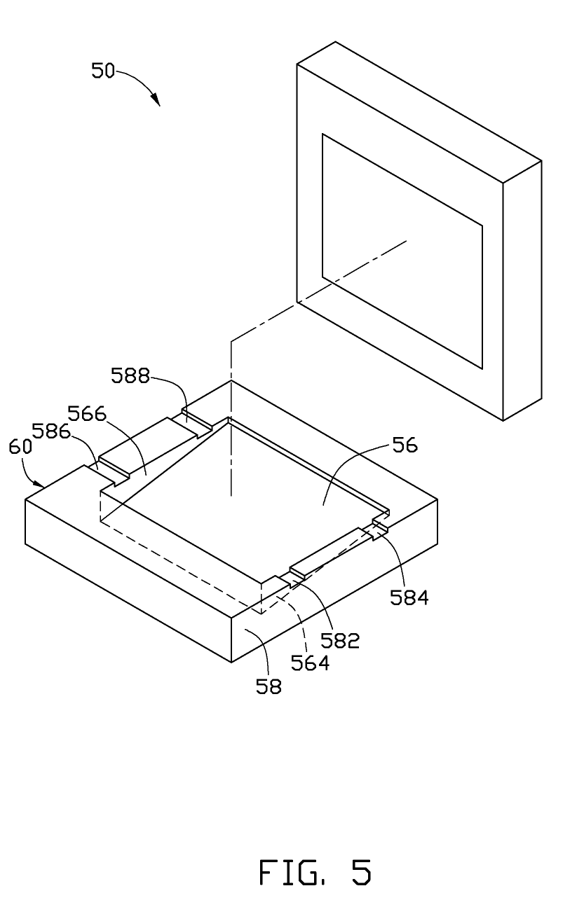

Referring to FIG. 5, this shows an injection mold 50 of a third exemplary embodiment. The injection mold 50 differs from the injection mold 10 in that the injection mold 50 further includes a third groove 586 and a fourth groove 588. Each of first and second grooves 582 and 584 extends a trapeziform side face 564 and an outer side face 58. Each of the third and fourth grooves 586 and 588 extends a trapeziform side face 566 and an outer side face 60. The trapeziform side face 566 is opposite to the trapeziform side face 564, and the outer side face 60 is facing away from the outer side face 58. In the illustrated embodiment, the third groove 586 is adjacent to a thick end of a wedge-shaped recess 56 in the second mold half 50b, and the fourth groove 588 is adjacent to a thin end of the wedge-shaped recess 56.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. An injection mold for making wedge-shaped light guide plate, comprising:
a molding assembly defining a mold cavity, the mold cavity being wedge-shaped and comprising a thick end and a thin end opposite to the thick end;
a first sprue and a second sprue in communication with the mold cavity, the first and second sprues being configured for introducing a molding material into the mold cavity, the first sprue being located at the thick end of the mold cavity and the second being located at the thin end thereof.

2. The injection mold of claim 1, wherein the mold assembly comprises a first mold half and a second mold half, the first mold half having a bottom surface, the second mold half having a top surface, a wedge-shaped recess being defined in the top surface, the second mold half having a rectangular bottom surface, two opposite rectangular side faces, and two opposite trapeziform side faces in the wedge-shaped recess, the rectangular side faces being parallel with each other and the trapeziform side faces being parallel with each other, the rectangular side faces and the trapeziform side faces adjoining the rectangular bottom surface, each of the rectangular side faces interconnecting one of the trapeziform side faces with the other, the depth of each of the trapeziform side faces relative to the top surface decreasing from one side to an opposite side, the wedge-shaped having a rectangular opening, the first mold half and the second mold half attached to each other such that the bottom surface of the first mold half arranged at the rectangular opening to form the wedge-shaped mold cavity.

3. The injection mold of claim 2, wherein the second mold half defines a first groove in the top surface adjacent to the thick end of the wedge-shaped recess and a second groove in the top surface adjacent to the thin end of the wedge-shaped recess, the first and second grooves configured for introducing the molding material into the mold cavity, the first groove and the bottom surface of the first mold cooperatively constituting the first sprue, the second groove and the bottom surface of the first mold cooperatively constituting the second sprue.

4. The injection mold of claim 3, wherein the first groove and the second groove extends through one of the trapeziform side faces.

5. The injection mold of claim 3, wherein the first groove extends through one of the trapeziform side faces, and the second groove extends through the other trapeziform side face.

6. The injection mold of claim 4, wherein the second mold half defines a third groove and a fourth groove in the top surface extending through the other trapeziform side face, the third groove being adjacent to the thick end of the wedge-shaped recess, the fourth groove being adjacent to the thin end of the wedge-shaped recess, the third groove and the bottom surface of the first mold half cooperatively constituting a third sprue, the fourth groove and the bottom surface of the first mold half cooperatively constituting a fourth sprue.

7. The injection mold of claim 4, wherein the first groove and the second groove are arranged at opposite sides of the wedge-shaped mold cavity.
